(19) United States
(12) Patent Application Publication
(10) Pub. No.: US 2006/0020055 A1
(43) Pub. Date: Jan. 26, 2006

(54) Erasable color lead

(75) Inventors: Nikolaj Krasnikov, Zirndorf (DE); Gerhard Lugert, Nuernberg (DE)

Correspondence Address: VENABLE LLP, P.O. BOX 34385, WASHINGTON, DC, 20045-9998, US

(73) Assignee: Faber-Castell AG, Stein (DE)

(21) Appl. No.: 11/186,800

(22) Filed: Jul. 22, 2005

(30) Foreign Application Priority Data
Jul. 23, 2004 (DE) 20 2004 011 610.3
Aug. 14, 2004 (DE) 20 2004 012 747.4

(51) Int. Cl. C09D 13/00

(52) U.S. Cl. 523/164

(57) ABSTRACT

An erasable colored lead is produced from a composition including a filler material, a coloring agent, an alginate as a bonding agent and at least one triglyceride derived from at least one fatty acid having 10 to 20 C-atoms.

### CROSS-REFERENCE TO RELATED APPLICATION

This application claims the priority of German Patent Applications No. 202004011610.3, filed on Jul. 23, 2004 and No. 202004012747.4, filed on Aug. 14, 2004, the subject matter of each of which is relied upon and is expressly incorporated herein by reference.

### BACKGROUND OF THE INVENTION

Conventional colored leads, used as components of wood or plastic enclosed colored pencils or as non-encased chalks, frequently contain high amounts of plastic particles composed of PTFE (polytetrafluoroethylene), LDPE (low density polyethylene) or PP (polypropylene) to make them erasable. European patent document EP 1093495 B1 may be exemplary. The plastic particles which are colored with the same coloring agent as the respective lead adhere to paper surfaces in such a way that they can be removed again with a rubber eraser. In addition to the complicated production process, known leads have the disadvantage of resulting in a halting, uneven, and difficult application when used on paper.

### SUMMARY OF THE INVENTION

It is an object of the invention to provide a colored lead which exhibits high color intensity, improved stroke behavior, and good erasability.

According to an exemplary embodiment of the invention there is provided an erasable colored lead comprising, filler material, coloring agent, an alginate as a bonding agent; and at least one triglyceride derived from at least one fatty acid having 10 to 20 C-atoms.

Surprisingly, it has turned out that a combination of these triglycerides, in particular those with melting points between 30° C. and 70° C., and alginates as bonding agents permits the production of leads which have all the desired characteristics, and as well exhibits high color intensity, improved stroke behavior, and good erasability. Alginates as bonding agents adhere less strongly to paper surfaces than cellulose derivatives, for example, and are therefore easier to erase, especially if combined with the solid particles of an added filler material; sodium alginate and potassium alginate either individually, or mixed together, have proven to be particularly preferred- bonding agents. With respect to stroke behavior and erasability, best results are achieved if a triglyceride selected from the group consisting of palm oil triglycerides, palm kernel oil triglycerides, capryl triglycerides, capric triglycerides, capryl/capric triglycerides are added to the lead mass.

Filler materials are preferably inorganic based materials which are generally best suited for this invention. Particularly suitable with respect to erasability is mica with a plate-like structure, for example in the form of muscovite and biotite. In addition, a mixture of mica and kaolin or mica and talcum can also be used. Preferably, color pigments are used as coloring agents since these barely adhere to the background, particularly paper, much less penetrate its fiber structure, as would be the case with soluble dyes.

The following composition represents a basic recipe for the leads according to the invention:
filler materials: 30 to 90%
pigments: 0.1 to 15%
bonding agent: alginate 1 to 10%
triglycerides 5 to 25%
additives: 0 to 10%

The foregoing percents are weight percents.

Standard admixtures such as surfactants and lubricants are considered for use as additives. Thus, a small amount of calcium stearate or sodium stearate can be added as auxiliary lubricant, wherein the admixture of calcium stearate results in a water-repellent lead. In contrast, an at least partial water-color quality can be achieved for the strokes of colored leads by adding even small amounts of sodium stearate.

The desired leads and chalks are produced by homogenizing the powdery material in high-intensity mixers or kneaders while adding water. Extrusion dies are then used to extrude the resulting granular material or paste-like material into chalks or leads which are subsequently dried at temperatures ranging from 60° C. up to a maximum of 120° C.

### DETAILED DESCRIPTION OF THE INVENTION

### EXAMPLE 1

The following composition is provided as an example for a yellow chalk (chalk diameter 1 cm):
potassium alginate: 2.0%
mica: 40%
talcum: 38%
calcium stearate: 4.0%
glycerides derived from saturated C12 to C18 fatty acids (CAS 9334-20-4 and CAS 91744-66-0): 14.0%
pigment yellow 1; CI 11680 2.0%
   The foregoing composition produces a water-resistant chalk with excellent erasability of the stroke.

### EXAMPLE 2

Erasable red color lead (lead diameter 3.0 mm):
sodium alginate: 6.0%
mica: 20.0%
kaolin: 58.0%
glycerides derived from saturated C12 to C18 fatty acids (CAS 9334-20-4 and 91744-66-0): 12.0%
pigment red 112, CI 12370: 4.0%

### EXAMPLE 3

Reddish brown, erasable colored lead (lead diameter 4.0 mm):
sodium alginate: 5.0%
mica: 20.0%
talcum: 10.0%
kaolin: 40.0%
capryl/capric triglycerides: 12.0%
stearic acid: 2.0%
pigment red 110 (CAS No: 1309-37-01) 11.0%

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. An erasable colored lead comprising:
filler material;
coloring agent;
an alginate as a bonding agent; and
at least one triglyceride derived from at least one fatty acid having 10 to 20 C-atoms.

2. The colored lead as defined in claim 1, wherein said at least one triglyceride has a melting point in the range of 30° C. to 70° C.

3. The colored lead as defined in claim 1, wherein said at least one triglyceride is derived from a saturated fatty acid.

4. The colored lead as defined in claim 1, wherein said at least one triglyceride is a derivative selected from the group consisting of palm oil triglycerides, palm kernel oil triglycerides, capryl triglycerides, capric triglycerides, and capryl/capric triglycerides.

5. The colored lead as defined in claim 1, wherein the bonding agent comprises sodium alginate, potassium alginate or admixtures.

6. The colored lead as defined in claim 1, wherein the filler material comprises at least one inorganic filler material.

7. The colored lead as defined in claim 6, wherein the inorganic filler material comprises mica.

8. The colored lead as defined in claim 7, wherein the filler material further includes at least one of talcum or kaolin or admixtures thereof.

9. The colored lead as defined in claim 1, wherein the coloring agent comprises color pigments.

10. The colored lead as defined in claim 1, characterized by the following composition:
30 to 90% filler materials;
0.1 to 15% color pigments;
1 to 10% alginate;
5 to 25% triglyceride; and
0 to 10% additives.

11. A pencil comprising a colored lead according to claim 1.

12. The pencil of claim 11, wherein said at least one triglyceride has a melting point in the range of 30° C. to 70° C.

13. The pencil as defined in claim 11, wherein the bonding agent comprises sodium alginate, potassium alginate or admixtures.

14. The pencil as defined in claim 1, wherein the coloring agent comprises color pigments.

15. A chalk comprising the colored lead according to claim 1.

16. The chalk as defined in claim 15, wherein said at least one triglyceride has a melting point in the range of 30° C. to 70° C.

17. The chalk as defined in claim 15, wherein the bonding agent comprises sodium alginate, potassium alginate or admixtures.

18. The chalk as defined in claim 15, wherein the coloring agent comprises color pigments.
